(19) United States
(12) Patent Application Publication
(10) Pub. No.: US 2014/0251349 A1
(43) Pub. Date: Sep. 11, 2014

(54) Contamination Containment Device

(71) Applicant: John Delatorre, Sugar Land, TX (US)

(72) Inventor: John Delatorre, Sugar Land, TX (US)

(73) Assignee: John Delatorre, Sugar Land, TX (US)

(21) Appl. No.: 14/187,229

(22) Filed: Feb. 22, 2014

Related U.S. Application Data
(60) Provisional application No. 61/776,658, filed on Mar. 11, 2013.

(51) Int. Cl. A61J 19/02

(52) U.S. Cl. CPC A61J 19/02
USPC 128/863

(57) ABSTRACT

A cough containment device is described, which may be a cup member having a top lid and filter joining portion, a second cap joining member for containment and a tissue holder. The invention is for coughing and sneezing and in the form of a cup with a hollow end at both parts of the cup. At one end is a cap with vents. The vents allow air to flow in and out of the cup. The user coughs through one end and airflow from coughing exits the filter on opposite end.

### BACKGROUND OF THE INVENTION

1. Field of Invention

The present invention relates to a device for capturing germs expelled when coughing and sneezing. Such a device may be portable, filtered and hand held replacing the use of a person's hand, arm, shirt sleeve, tissue or some other means when coughing and sneezing. More importantly, the device can be sealed making the device safe for others to hold or transport after it has been used by others. For example, a child would be able to use the device and when done, seal the device and hand the device to a parent without the parent becoming contaminated. The device could be made to be washed and reused or disposable.

Cold and flu season is one of the worst times of years for most people since we can expect to get sick and try all kinds of means of avoiding germs and contamination. Unfortunately, too many of us are unable to avoid getting sick.

While viruses and germs are airborne and too often unavoidable, what is avoidable is the spread by touching, coughing and sneezing on each other. What is needed is a device that would make it easier for people to capture their germs and viruses when coughing and sneezing.

Young children are quite often the worst kind of transmitters of germs and viruses since they tend to touch everything they come in contact with. Once a child touches his eyes, nose or mouth, it's only a matter of time before he touches everything else in site. Eventually other children come in contact with the germs and viruses and the contamination spreads from schools, to home and eventually our place of work.

Health officials tell us to wash our hands after coughing and sneezing in an effort to avoid the spread of germs. Good luck getting a 5 year old to comply. Ask children under 8 years old how they cover their mouths when they cough or sneeze and chances are they will show you a half dozen or more different methods.

For generations children of all ages have been taught to cover up when coughing or sneezing. Not too long ago, a new method was introduced; to cough and sneeze into your shirt sleeve. What if you're not wearing a long sleeve shirt?

2. Description of the Prior Art

One solution to controlling the spread of germs is to wear a mask such as those worn by construction workers to avoid dust or those used by nurses and doctors during surgery. While these masks may reduce the risk of spreading germs or catching a cold, wearing them is not practical for everyday use, nor an attractive option.

In U.S. Pat. No. 3,719,188, issued 1973, Frank E. Fisher illustrates a portable flask-like device used to capture contagions. The device requires a mask and together, while portable not convenient.

In U.S. Pat. No. 4,604,110, issued Aug. 5, 1986, Stephen E. Frazier illustrates a chemically-treated filter used to eliminate or at least reduce bacteria and odors. Frazier treated the filter with a gel-like substance and Wallace J. Rogozinski later applied a similar solution to a mask filter illustrated in his U.S. Pat. No. 5,269,294, issued Dec. 14, 1993. Similar filters have shown to be effective in their use.

In U.S. Pat. No. 5,810,003, issued Sep. 22, 1998 to Barrington M. Findlater illustrates a chemically-treated device that delivers decongestion vapors to the nostril of infants without having to put chemicals directly on the child. Findlater references Procter & Gamble® a company that makes the product VICKS® used to relieve congestion.

A limitation in Findlater's device is that the chemically treated device is not contained but rather exposed to the environment. Having the chemically-treated device exposed to the environment would mean the usefulness of the vapors would be diminished much more rapidly than if the device was contained inside a device.

In U.S. Pat. No. 5,647,377, issued Jul. 15, 1997 to Joe E. Shinabarger illustrates a tube-shaped device. Shinabarger's device is solely for the purpose of reducing the sound emitted from a person coughing and/or sneezing. It is not meant to filter air, medicate the air or control germs. Shinabarger's device is one of the first signs that such a tube-like device could be used when coughing and/or sneezing.

In U.S. Pat. No. 6,986,348, issued Jan. 17, 2006 to Michael Terry Carter illustrates a tube-like mask device. Combining a tube-like structure and a mask, Carter's device uses one way valves inside a cylinder to capture contagions. Carter claims the device is disposable and captures 99.99 percent of bacteria and 99.90 percent of viruses.

A limitation in the device is his use of one way valves making it easier to exhale a cough but the user is required to remove their mouth from the device before they inhale. A person needing to cough several times consecutively would find it difficult to breathe normally using the device.

In US Patent Application 2006/025459 by David Marx, published Nov. 16, 2006, Marx illustrates a mask with lifter that a person holds up against theft face to capture and store germs from sneezing and coughing. The mask folds to be stored in a pocket or purse until once again needed.

A limitation in the device is that placing such a device on one's face would limit the amount of air available for inhalation. Coughing and sneezing are a part of exhaling air and a person would have to remove the device from theft face to inhale more easily. This could be a problem, especially for children suffering from asthma.

In U.S. Pat. No. 8,091,552, issued Jan. 10, 2012 to Lee D. Stockhamer illustrates a pad-like device for the purposes of capturing germs attached to the crease of a person's arm opposite the elbow. The device when held up to the mouth and/or nose is designed to capture contagions when coughing and sneezing. While the device appears convenient and creates a place for coughing and sneezing when a person does not wish to cough or sneeze into a shirt sleeve or where there is no shirt sleeve, a limitation in the device is that it is left exposed after use and could contaminate others. It is believed others would want to avoid coming near persons wearing such a device fearing exposure. It is believed the device would not be socially acceptable for use in a public setting.

In U.S. application Ser. No. 12/108,077 by Ronald A. Mazzone published Oct. 29, 2009 illustrates a sound suppression disposable device with an anti-bacterial filter fixed within a tube for use when coughing to capture contagions and lower sound level. As with previous prior art, Mazzone does not provide a method of closing the device prior to or after its use. Having a way to seal the device would insure others who might come in contact with the devise would not be contaminated.

Another limitation of Mazzone's device is the use of a lanyard to be placed around a person's neck. While this may not be a problem for adults, it could pose a safety hazard for young children.

Another limitation of the device is its use of two open ends and thus a person may not understand which end to use when coughing. If a person was to cough into the wrong end, it is possible the user might push contaminates out the other end onto others.

Another limitation of the device is the absent of a valve to improve breathing after coughing and sneezing.

In U.S. Pat. No. 7,997,275 issued Aug. 16, 2011 to Michael Quinn illustrates a mask type device with vent ports used to capture germs when coughing or sneezing. Like Mazzone's device, Quinn's device uses an anti-bacterial filter. Quinn fixes the filter into a mask and uses vent ports to relieve pressure when coughing and sneezing into the device.

A limitation of Quinn's device, like Mazzone's is that a person is unable to seal the device after it is used. Having a way to seal the device would insure others who might come in contact with the devise would not be contaminated.

Another limitation of Quinn's device is the distance between a person face and the device. The close proximity of the device, it's filter and a person's face could result in the discharge coming from a person's nose or mouth to be splashed back into the user's face. The parallel angle of the device with respect to a person's face increases the chance discharge from the nose or mouth splashing back into the user's face thus lower the chance a person would want to once again place the device over their mouth and nose when needed a second time.

In U.S. application Ser. No. 12/724,736 by Amy M. Johnston and et al., published Sep. 22, 2011 illustrates a cone-shaped device used to capture contagions when coughing and sneezing. Johnson illustrates a convenient method for using the device much like people carrying a handkerchief or tissue. Johnson adds a medicated portion fixed to a cavity and an adjustable opening for capturing germs.

A limitation of Johnson's device is that it requires the user to place the device directly against the skin increasing the chances of discharge being splashed back into the user's face. Using basic tissue limits this splash back by concentrating on capturing discharge from a person's mouth and/or nose at the very closest point of discharge.

Another limitation of the Johnson device is that the idea of using the device a second time is about as attractive as using a handkerchief or tissue a second time.

What is needed beyond the masks and tubes of prior art is a device that can be sealed after each use reducing the risk of contaminating others, allows for easy inhalation after coughing, reduces the likelihood of a discharge splash-back-like effect after coughing, can be manufactured almost as cheaply as tissue so as to encourage widespread use and considered culturally and socially accepted to be used in public settings.

It has been shown that other devices have accomplished finding ways to reduce the spread of germs and viruses, filter the air and muffle the sound of a person coughing and/or sneezing. But, what is needed is a device that can achieve all of these benefits in such an inexpensive way that major corporations will want to give these devices away to the general public as an act of good will. It is believed that the low cost of each device would be an incentive for pharmaceutical companies to print their names on the device and give them to school children or place them in doctor's offices and hospitals as give-away items also known as premiums to those familiar with promotional products.

To create such a device would mean it would need to be one of the simplest, most basic forms known to man. Furthermore, it would have to be a device people are already familiar with thus making them more comfortable and more likely to use the device in a public setting. If such a device is to be used in public, it would have to be perceived as culturally and socially acceptable, much like the use of tissue.

Prior art may have set out to change the way we behave when sick but changing one's behavior is dependent on peer pressure, cultural norms, human interaction, fashion and a host of other reasons and not just on the device itself.

Consider how long we have been coughing and sneezing into our hands and yet few, if any, of the earlier inventions have changed the way we behave in large measure beyond using tissue or covering up our face with our hands. A relatively new fashion trend is to cough and sneeze into our sleeves. How do you think that is working out?

History is showing us not much has changed when it comes to how humans behave when coughing and sneezing. But one thing that is changing is the spread of germs and viruses. Consider the so-called “superbugs”; the strains of germs and viruses that are no longer immune to antibiotics. Consider also our global economy with more and more people traveling. Germs and viruses are traveling the world and spreading like never before. If ever there was a time to change the way we behave when sick, it's now.

It is clear a device to control the spread of germs and viruses is desperately needed. But, if people are going to use such a device to control coughing and sneezing, manufacturers and marketing experts know such a device must be immediately and easily understood by the general public. Marketing experts know that if you have to teach someone how to use a product, then there is a much greater chance the product will fail.

To achieve widespread change in human behavior is not easy but to do so would require a cough containment device that is as basic and inexpensive and as socially and culturally accepted as tissue. As mentioned in prior art, Johnson's device was an attempt at doing this but as earlier stated, it is believed that using Johnson's device a second time would not be socially nor culturally accepted in public.

### SUMMARY OF THE INVENTION

The present invention is an attempt to create a common everyday item that can be used to capture germs when coughing and sneezing, can be socially and culturally accepted and be manufactured at a price that makes it economically feasible for large companies to give the device away for free. That common every day item would be in the form of a cup; a coffee cup and would be trademarked Coughy Cup™, a play on words but hardly child's play. The device would be in the form of a cup made from paper, Styrofoam, plastic or any other suitable material with or without an appendage for holding. When referring to coffee cups, it should be understood that this includes coffee mugs. Coffee cups are also referred to as coffee mugs. In this case, a smaller version of the device would be called a Coughy Mug™ also referred to as Mother's Little Helper™

Millions of people each day drink coffee from a paper, plastic or Styrofoam cup; some with lids, others without. These types of cups are extremely common. In fact, billions of them are produced each year in the U.S. alone. Paper cups and their plastic lids can be produced for pennies. Furthermore, they are socially acceptable. They can be found in millions of homes, schools, businesses and stadiums around the world. This means they are socially and culturally accepted. In fact, one might argue disposable coffee cups are as common as disposable tissue. With the exception of a few small holes, a filter and a lid, there is very little difference between a Coughy Cup™ and a coffee cup. And, that's what makes the device unique. Using the trade name Coughy Cup™ and/or Coughy Mug™ with a coffee cup-like device makes sense and would make it easier for the general public to understand what the device is to be used for and would increase the chances its use will be socially and culturally accepted.

Imagine large companies like Johnson and Johnson®, Pfizer®, Eli Lilly® and others wanting to sponsor programs to help children stay healthy. Imagine the makers of cough medicines like Vicks®, Halls®, Tylenol®, Sudafed®, Robitussin® and many others all wanting to show they care by giving away such a cough containment device free of charge to children throughout the world. If the marketing department managers from these large pharmaceutical companies and others like them can be shown a device that costs pennies to make and can be used to help children stay healthy, it is believed they will pay for that kind of positive public image. The parents will most likely appreciate their good will and later buy their products.

It is a win/win for everyone. It is a win for the pharmaceutical companies because they can purchase the cups, print their logos on the cups and give the cups away as an act of good will, improved public relations and advertising.

Imagine if such a device could be provided to nursing homes and hospitals where millions of our elderly and others constantly sit around coughing and sneezing.

Now imagine if such a device was available at schools and daycare centers. It could be given to the millions of our youngest children who are some of the most vulnerable to colds and flu. Parents could pack the device into their child's book bag and in the event the child needs it, it will be ready for use.

As previously stated, a product that can be made for a few cents each has many benefits. It can be made to be disposable or a reusable/washable version could also be manufactured. The low cost of the device could also mean school nurses could provide the device to children while they wait for their parents to take them home or to see a doctor.

Furthermore, such a device would give teachers an improved method of monitoring which students are sick or possibly getting sick. And, the device could be used as a learning tool to teach children to control their germs. Even if such coughing and sneezing are only associated with allergies, an itchy or dry throat or some other reason, the device would still help children to be considerate of their fellow classmates. This would be the beginning of changing human behavior by teaching children what is and is not socially and culturally accepted.

The device would also provide a focus for performing a single common behavior. Any child needing the device would simply leave it sitting on their desk next to their things. When a child is done using the devise for the day, the child would simply close the cup to contain any germs and/or viruses and toss it in the trash. If they are using the reusable version, they would simply take the device home to be washed and made ready for next time it is needed.

If a child does not have a cough but is sneezing, the child would use the device to dispense tissue and discard the used tissue inside the cup. In this case, the device would be used as a waste receptacle to keep the contaminated tissue away from others. Research shows children who put used tissues in their pockets increase the spread of germs and viruses.

Using such a device at home would also mean not spreading germs and viruses to family members. The spread of germs and viruses are further minimized because the device is fully contained with caps on both ends. A child's hands never come in contact with the inside of the device during its proper use and the air coming out of the device is filtered.

The device could also be placed in doctor's offices and waiting rooms of all kinds. The low cost of such a device would encourage businesses to leave them sitting on waiting room tables as a free item to be used as a courtesy to others. Patients sitting around coughing and sneezing without using the readily available free item would most likely be ostracized by others staring at them for not using the device.

It is believed that how we behave when coughing and sneezing has not changed because a simple, low cost, socially and culturally acceptable device has yet to be introduced into the marketplace. Imagine if tissue was never invented. We would still be using cloth handkerchiefs and how practical would that be today? Do some people still use cloth handkerchiefs? Yes, of course but not many. Just as few people today use cloth diapers.

### BRIEF DESCRIPTION OF THE DRAWINGS

The present invention is illustrated by way of example, and not by way of limitation, in the figure of the accompanying drawings and in which like reference numerals refer to similar elements and in which:

FIG. 1 is an environmental view of an exemplary contamination containment device according to an embodiment of the present invention,

FIG. 2 is an exploded view of the exemplary contamination containment device illustrated in FIG. 1, according to an embodiment of the present invention.

FIG. 3, FIG. 4, FIG. 5, FIG. 6 and FIG. 7 are detailed views of exemplary components of an exemplary contamination containment device illustrated in FIG. 1, according to an embodiment of the present invention.

FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27 and FIG. 28 are alternative views of the exemplary contamination containment device illustrated in FIG. 1, according to an embodiment of the present invention.

Unless otherwise indicated illustrations in the figures are not necessarily drawn to scale.

To achieve the forgoing and other objects and in accordance with the purpose of the invention, a variety of contamination containment device are described.

An embodiment of the present invention is comprised of a cup, a top lid, a bottom lid, and filters. The cup is designed with side vents, a valve, a tissue holder and a tissue dispenser opening. The cup valve is designed to seal and unseal the cup so air can flow into the cup. The valve closes and seals the cup when a person coughs sending air only through the filter. After a person coughs, the lack of pressure from coughing allows the valve to open. When the valve is open a person can breathe air in from both the filter and the side vents of the cup.

The top lid is designed to hold a filter. The top lid also has vents so air can flow in and out of the cup. The bottom lid is designed to seal and unseal the device for use. The filters come in two forms; a disk filter and a pocket filter. The disk filter is designed to capture and kill germs and viruses and is attached to the inside portion of the top lid and is removable (e.g. without limitation, the disk filter can be disposable or non-disposable). The pocket filter is also designed to capture and kill germs and viruses and is attached to the inside portion of the cup and is removable (e.g. without limitation, the pocket filter can be disposable or non-disposable). Furthermore, the device is designed so that the disk filter and the pocket filter can be used one at a time or both simultaneously for maximum control of germs and viruses.

In alternate embodiments of the present invention, the cup portion of the device may also be designed without side vents, without a valve, without a pocket filter and without a tissue dispenser.

Other features, advantages, and object of the present invention will become more apparent and be more readily understood from the following detailed description, which should be read in conjunction with the accompanying drawings.

### DETAILED DESCRIPTION OF THE INVENTION

The present invention is best understood by reference to the detailed figures and description set forth herein.

Embodiments of the invention are discussed below with reference to the Figures. However, those skilled in the art will readily appreciate that the detailed description given herein with respect to those figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate and alternative embodiments do not necessarily imply that the two are mutually exclusive.

The present invention will now be described in detail with reference to embodiments thereof as illustrated in the accompanying drawings.

It is to be understood that any exact measurements/dimensions or particular construction materials indicated herein are solely provided as examples of suitable configurations and are not intended to be limiting in any way. Depending on the needs of the particular application, those well skilled in the art will readily recognize, in light of the following teachings, a multiplicity of suitable alternative implementation details.

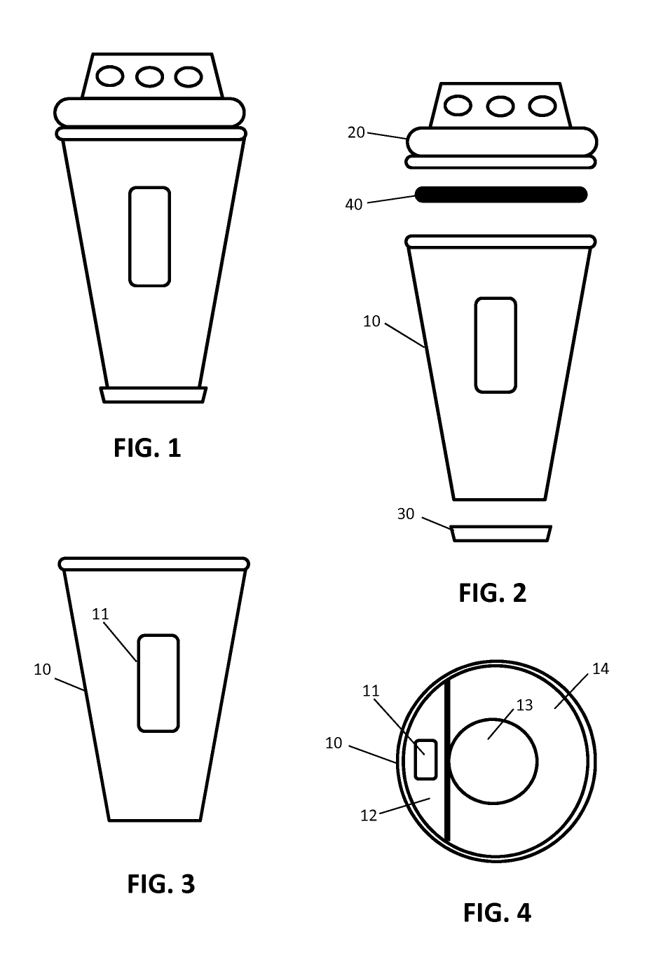

FIG. 1 is an environmental view of an exemplary contamination containment device, according to an embodiment of the present invention. As shown by way of the example, and not by way of limitation, in FIG. 1 a contamination containment device made in accordance with the present invention comprises 4 elements, shown separately in FIG. 2.

FIG. 2 is an exploded view of the exemplary contamination containment device illustrated in FIG. 1, according to an embodiment of the present invention. In the present embodiment, the contamination containment device comprises a cup 10, a top lid 20, a bottom lid 30 and a filter 40.

FIG. 3, FIG. 4, FIG. 5, FIG. 6 and FIG. 7 are detailed views of the exemplary components of a contamination containment device, according to an embodiment of the present invention.

FIG. 3 shows a front view of exemplary cup 10 and tissue dispenser opening 11.

FIG. 4 shows a top view of the exemplary contamination containment device cup 10, tissue dispenser opening 11, tissue holder cavity 12, cup 10 small opening 13 and cup 10 large opening 14. A person places tissue into tissue holder cavity 12. When a person needs to sneeze, the person removes tissue by pulling tissue through tissue dispenser opening 11.

FIG. 5 shows a bottom view of the exemplary contamination containment device cup 10, cup 10 small opening 13 and tissue dispenser opening 11.

FIG. 6 shows a side view of top lid 20, lid vent 21 and filter 40 inserted into top lid 20. Filter 40 may be constructed of a variety of materials, such as, but not limited to cotton, polyester etc. In the preferred embodiment, filter 4 is disk shaped and made of polyethylene terephthalate and cotton and coated with a layer of citric acid and sodium lauryl sulfate; common ingredients found in everyday consumer products. Citric acid is used to flavor soft drinks. Sodium lauryl sulfate is used in shampoos and detergents. Citric acid and sodium lauryl sulfate, when combined, has been proven to kill 99.9 percent of the viruses and germs within 15 minutes of contact. In the preferred embodiment, top lid 20 and bottom lid 30 are made of polystyrene.

FIG. 7 is a top down view of filter 40 illustrated by way of example and not by limitation, logo 41 printed on filter 40. Filter 40 could be flavored, scented or medicated. Users of the device would most likely look inside the device thus the advertising company would benefit or disk filter 40 might be inside a packet before installation. In this case, the advertising could be on the packet and filter 40 to be seen prior to the user of the device installing filter 40.

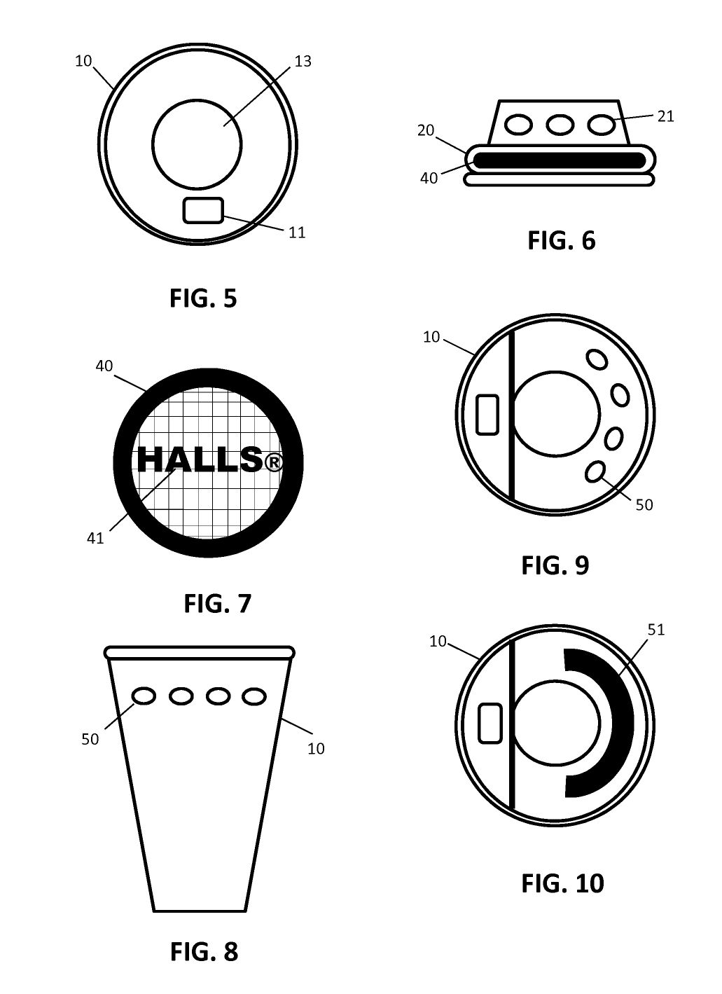

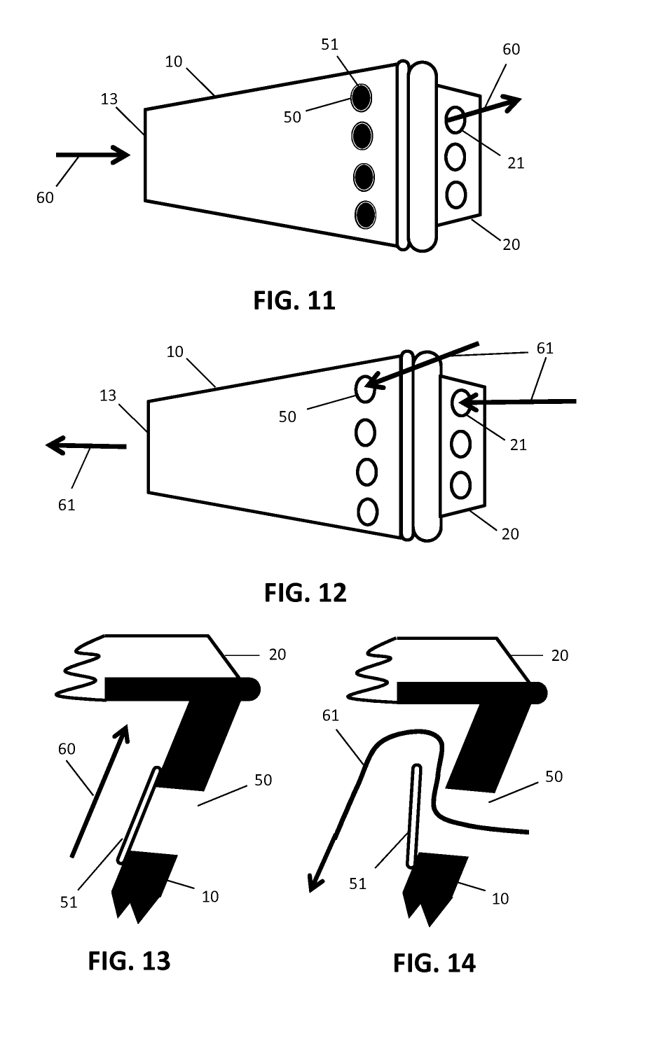

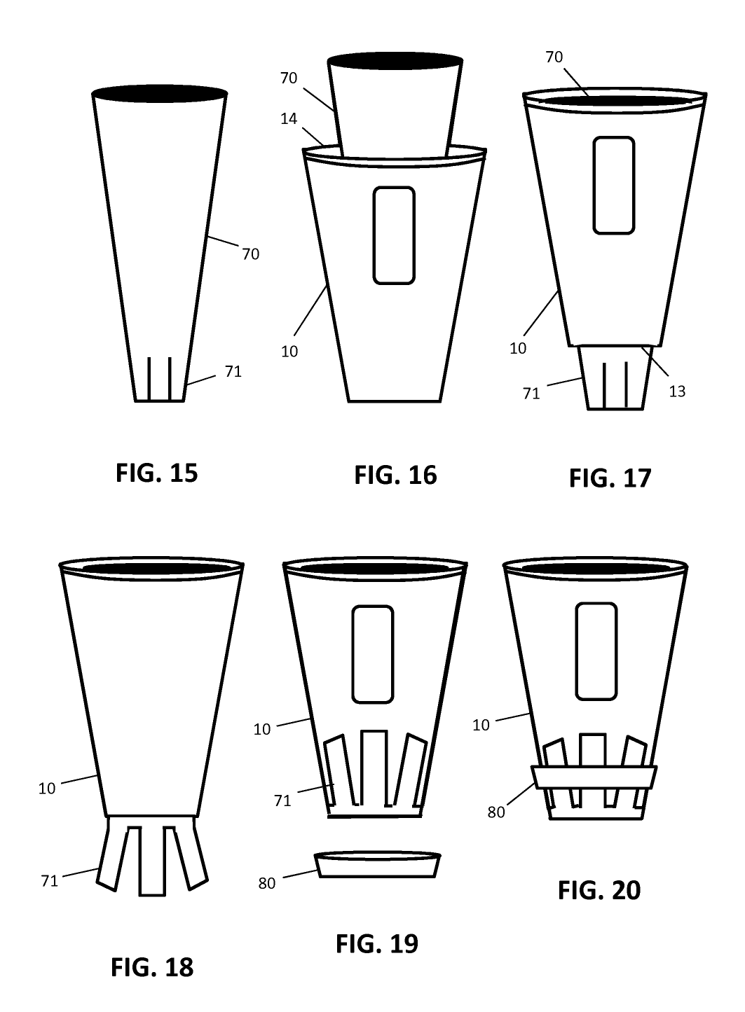

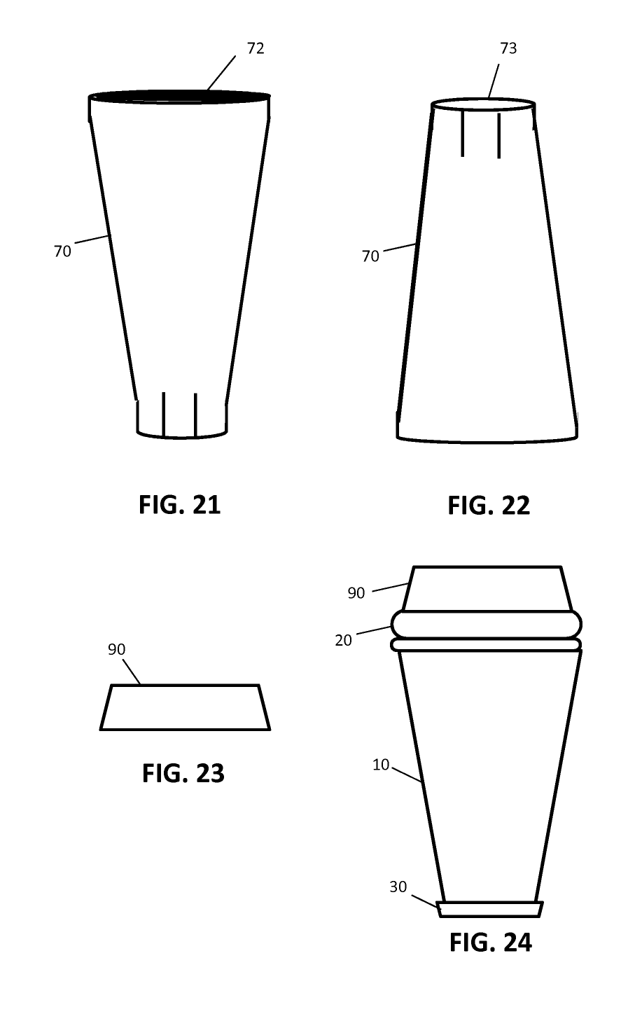

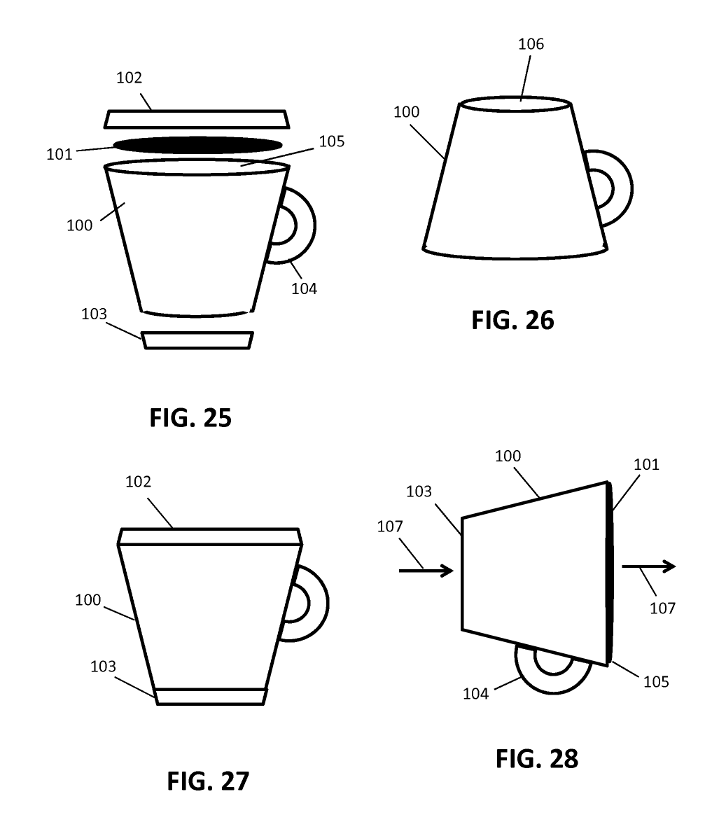

FIG. 8 shows a back view of exemplary cup 10 and cup vent 50.

FIG. 9 shows a top view of cup 10 and cup vent 50.

FIG. 10 shows a top view of exemplary cup 10 and cup vent valve 51.

FIG. 11 illustrates, by way of example and not by limitation, cough airflow 60 entering cup 10 small opening 13 and cough airflow 60 exiting top lid 20 through vent 21.

Furthermore, FIG. 11 illustrates, by way of example and not by limitation, cup vent 50 which comprises of a cup vent valve 51 used to open and close cup vent 50. The increase in pressure from a person's cough forces cup vent valve 51 to close and airflow 60 to bypass cup vent 50 and exit cup 10 and top lid 20 at cup vent 21.

FIG. 12 illustrates, by way of example and not by limitation, the direction of airflow 61 from a person inhaling through cup 10 small opening 13 with airflow 61 entering lid vent 21 and cup vent 50 and airflow 61 exiting cup 10 through cup 10 small opening 13. The decrease in pressure after a person coughs allows cup vent valve 51 to open and inhale airflow 61 to enter cup vent 50. Without the use of cup vent 50 and cup vent valve 51, airflow 61 would only enter cup 10 through top lid 20 lid vent 21. Airflow 61 that enters only through top lid 20 is forced to go through filter 40, which could make inhaling more difficult.

FIG. 13 illustrates, by way of example and not by limitation, a cross-section view which comprises of cup vent 50 and cup vent valve 51 closed over cup vent 50 so that airflow 60 cannot exit cup 10 at cup vent 50.

FIG. 14 illustrates, by way of example and not by limitation, a cross-section view which comprises of cup vent 50 and cup vent valve 51 not closed over cup vent 50 so that airflow 61 can enter cup 10 at cup vent 50.

FIG. 15 shows a side view of pocket filter 70 and pocket filter tails 71. Pocket filter 70 may be constructed of a variety of materials, such as, but not limited to cotton, polyester etc. In the preferred embodiment, pocket filter 70 is made of polyethylene terephthalate and cotton and coated with a layer of citric acid and sodium lauryl sulfate.

FIG. 16 shows pocket filter 70 entering cup 10 at large opening 14.

FIG. 17 is a side view of cup 10 with pocket filter 70 inside cup 10 and pocket filter tails 71 extending out of cup 10 small opening 13.

FIG. 18 is a side view of cup 10 with pocket filter 70 inside cup 10 and pocket filter tails 71 spread apart.

FIG. 19 is a side view of cup 10 with pocket filter tails 71 folded back over cup 10 and cup sleeve 80.

FIG. 20 is a side view of cup 10 cup sleeve 80 pulled over pocket filter tails 71 to secure pocket filter 70 and pocket filter tails 71 to cup 10.

FIG. 21 is a side view of pocket filter 70 and close end 72.

FIG. 22 is a side view of pocket filter 70 open end 73. Just like a pillow case only has one open end, so it is also true of pocket filter 70. The only part of pocket filter 70 that is an open end is open end 73.

FIG. 23 is a side view of lid cover 90.

FIG. 24 is a side view of lid cover 90 covering a portion of large lid 20. Lid cover 90 is used to close top lid 20 lid vent 21 and bottom lid 30 is used to close cup 10 small opening 13.

FIG. 25 is a side view of a side view of cup 100, filter 101, top lid 102, bottom lid, 103, cup holder 104 and top opening 105. The cup 100 shown in FIG. 25 is of a kind more commonly seen in homes and offices.

FIG. 26 is a side view of cup 100 bottom opening 106.

FIG. 27 is a side view of cup 100, top lid 102 and bottom lid 103. The cup 100 shown in FIG. 27 illustrates by way of example but not by way of limitation, the closing of cup 100 using top lid 102 and bottom lid 103 making the device ready for disposal.

FIG. 28 is a side view of cup 100, filter 101, small opening 103, cup holder 104, large opening 105 and airflow 107. A person would use the device cup 100 by holding by hand cup holder 104 and then coughing airflow 107 into small opening 103 and said airflow 107 exiting large opening 105 and filter 101.

It should be understood there are other ways to design the present invention that include certain aspects of prior art. It is to be understood that the relationship of the parts and their dimensions include variations in size, materials, shape, form, function and manner of operation, assembly and use and are deemed readily apparent and obvious to one skilled in the art. It is further understood that any equivalent relationships illustrated in the drawings and the specifications described are not intended to limit the invention to the exact construction and operation shown and described since numerous modifications and changes will readily occur to those skilled in the art.

Having fully described at least one embodiment of the present invention, other equivalent or alternative cough containment devices according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A cough and sneeze containment device comprised of;
an operative configuration that is a hollow structure with a mouth-nose opening for coughing and sneezing on one end of said hollow structure and a non-mouth-nose opening on the opposite end of said hollow structure; at least one vent opening on side of said hollow structure; at least one removable vent cover; a side opening of said hollow structure for dispensing tissue; a tissue storage slot wherein said tissue storage slot attaches to interior wall of said hollow structure and wherein said tissue storage slot is positioned over said side opening; a removable tissue packet wherein said removable tissue packet attaches over said side opening of interior wall of said hollow structure and said removable tissue packet is inserted into said tissue storage slot; a removable top lid for coughing and sneezing configured to receive the mouth and nose of a person and wherein attaches to said mouth-nose opening of said hollow structure; a filter membrane for mitigating germs and viruses from coughing and sneezing is placed into said mouth-nose opening of said hollow structure; a said second layer of filter is joined to said filter membrane; a gasket attaches to said filter membrane and said second layer of filter wherein said gasket is used to attach said filter membrane and said second layer of filter to removable top lid and a removable bottom lid wherein said removable bottom lid attaches to said non-mouth-nose opening of said hollow structure.

2. The device of claim 1, in which said filter membrane is operable to be received into said hollow structure.

3. The device of claim 2, further comprising in which said filter membrane is a nonwoven fabric-like material consisting of at least one layer of material for the purpose of mitigating germs and viruses.

4. The device of claim 3, further comprising in which said filter membrane is operable generally in the shape of a pocket.

5. The device of claim 4, further comprising in which said pocket is generally operable pleated.

6. The device of claim 1, in which said second layer of filter is joined to said filter membrane for the purpose of minimizing the collapse of said pocket when a person inhales after coughing and sneezing.

7. The device of claim 6, further comprising in which said second layer of filter is a mesh-like material consisting of at least one layer.

8. The device of claim 2, in which said filter membrane is impregnated with a microbicide consisting of an antiviral, antimicrobial, antibacterial, viricide or some combination thereof for the purpose of killing germs and viruses.

9. The device of claim 1, in which said gasket attaches to said filter membrane and said second layer of filter by way of ultrasonic welding for the purpose of maintaining a circular shape opening of said pocket.

10. The device of claim 8, further comprising in which said gasket is made of paper or plastic.

11. The device of claim 1, in which said tissue portion attaches over said side opening of interior wall of said hollow structure by way of inserting said tissue portion into said tissue storage slot.

12. The device of claim 11, further comprising in which said tissue portion at least one sheet of tissue is dispensed through said side opening of said hollow structure.

13. The device of claim 1, in which said removable top lid includes at least one opening configured to receive a mouth and nose of a person.

14. The device of claim 13, further comprising in which said removable top lid attaches to said mouth-nose opening of said hollow structure by way of twisting and snapping.

15. The device of claim 1, in which said removable bottom lid attaches to said non-mouth-nose opening of said hallow structure by way of twisting and snapping.

16. The device of claim 1, in which said hollow structure comprises of at least one said vent opening for air to move in and out of said hollow structure.

17. The device of claim 16, further comprising in which said hollow structure consists of at least one said vent cover for regulating airflow in and out of said hollow structure.

18. The device of claim 17, further comprising in which said vent cover is flexible and made of paper or plastic.

19. The device of claim 18, further comprising in which said vent cover attaches to said vent opening at interior wall of said hollow structure and whereby said vent cover pivots open and close from airflow created from coughing and sneezing.

20. The device of claim 1, in which said hallow structure said removable top lid and said removable bottom lid can each be individually made of paper, plastic, metal or glass.
